(19) United States
(12) Patent Application Publication
(10) Pub. No.: US 2023/0080676 A1
(43) Pub. Date: Mar. 16, 2023

(54) DEVICE FOR AUTOMATIC WINDOW CLEANING AND VENTILATION

(71) Applicant: Luka PATCHKORIA, Tbilisi (GE)

(72) Inventor: Luka PATCHKORIA, Tbilisi (GE)

(21) Appl. No.: 17/795,232

(22) PCT Filed: Jan. 29, 2021
(86) PCT No.: PCT/GE2021/050002

§ 371 Date: Jul. 26, 2022

(30) Foreign Application Priority Data
Feb. 4, 2020 (GE) AP 2020 15271

(51) Int. Cl. A47L 1/02; E04G 23/00; E06B 7/02

(52) U.S. Cl. CPC A47L 1/02; E04G 23/002; E06B 7/02

(57) ABSTRACT

The invention belongs to the devices for automatic cleaning and ventilation of windows from the facade of high-rise buildings. The technical result of the proposed invention is the simplification of the construction of the device, which makes it possible to clean the glass surface without human resources, which is also financially profitable. In this case, the glass cleaning, which is carried out by a climber and costs from 7 to 28 dollars per square meter, is reduced to 1 dollar per square meter through the proposed invention. The essence of the invention lies in the fact that the proposed device contains an additional washing solution valve equipped with pipes, ventilation box, ozonator, filters, speakers and control panel, water valves, as well as a water valve with a flushing solution for the pipe. In the first section of the frame, the water valve is also connected to the outlet pipe.

The invention belongs to the devices for automatic cleaning and ventilation of windows from the facade of high-rise buildings and is equipped with an indoor ventilation system.

1.1 When cleaning windows of high-rise buildings are needed and manual cleaning is technologically impossible or dangerous, specialists are required who use mountaineering equipment to clean the windows. This type of service is expensive and also associated with high risks. Therefore, it is now relevant to develop compact and automatic window cleaning devices for quick and efficient window cleaning that are compact and easy to install.

1.2 Window cleaning device are known that contain a screw guide, electric motor, handrail and window cleaning brush, where the screw guide is made with the ability to attach to the window frame and connect to the outlet shaft of the electric motor.

1.3 The crane is attached to the screw guide and is made with the ability to move on it. The glass cleaning brush is attached to one side of the stand, perpendicular to the axis of the screw guide. And on the opposite side of the brush attachment, the bridge is attached to the dumbbell to prevent the dodger from turning when moving on its screw guide. The device is characterized by complexity of construction.

1.4 Window cleaning devices that includes a body, a rectilinear guide, a screw guide, an electric motor, a handrail and a window cleaning brush are known. The body is made with the ability to attach to the window frame and is equipped with a linear guide, on which is placed a handrail to move along it. The connection point of the linear guide and the handrail is made by the “slit-cut” type of connection to avoid the displacement of the handrail in the straight line of perpendicular plat.

1.5 The handrail is also connected to the screw guide by the ability to move on it, in turn, the screw guide is connected to the output shaft of the electric motor and is placed on the body in such a way that its axis of rotation is parallel to the straight liner axis. The cleaning brush is attached to the handrail and able to make contact with the cleaning surface.

1.6 The device is characterized by complexity of construction.

Known are devices for automatic cleaning of smooth glass surfaces, which contain a body, a washer element, systems for moving along the cleaning surface by means of an electric motor, for delivering the washing solution to the cleaning surface and for operating, where the device for moving is a straight line and two moving modules with handrails, attached vertically to opposite ends of the window frame. On the handrail an elongated horizontal support is attached, on which at least one mechanism is attached to ensure a top-down switch.

The rinsing element is made in the form of at least two elastic bands arranged at a sharp angle to each other. The rinsing solution delivery system is a reservoir with washing liquid to which the pump is connected; The washing liquid is supplied to the hoses and then the tubes, which are placed vertically inside the linear displacement module; the washing liquid is delivered to the cleaning surface through holes made in the linear displacement module.

The system for managing the operation of the device contains a power supply unit that receives electricity from the converter 12-24 B; The control system for moving the cleaning surface along the cleaning surface, the rinsing solution to the cleaning surface, and the device control are controlled by the control software. The device is characterized by complexity of construction. During operation of the device, it is also possible for the cleaning element to deviate from the working location.

Also known is a device characterized by the inflow of air from outside space through the window opening, which has disadvantages: natural precipitation, insects, dust, bacteria and generally polluted air and expensive mechanism for opening a window.

The closest prototype from the hardware level is a device for automatic window cleaning (national intellectual property centre, Invention Application #AP 2018 14878).

Prototype device for automatic window cleaning, includes housing, window cleaning element, window cleaning element moving tank, tank for washing solution equipped with hoses and associated pump, reversing electric motor and software power control unit. In addition, the sliding window cleaner is made in the form of toothed belts, and the body is made of the frame with the ability to attach to the window frame and designed so that the upper part of the frame consists of separated two sections, one horizontally placed above the window surface, and the other on the facade side.

In the first section there is a reservoir 1 for the washing solution, a pump 2 connected to it, a hose 3 connecting the reservoir 1 with the pump 2. The hose 4 exits the solution from the pump. The hose for entering the solution into the tank 5 and the program electric control unit 6. And in the second section, an aluminium perforated tube 7 passes along its entire length, connected to the hose 4, at the outlet of the pump, on one side of the second section is a reversible electric motor 9, mounted on a bracket 10. In addition, the motor shaft is connected to the cylindrical first shaft 11a for rotation along it with connecting element 12, where the shaft 11a is inserted between two bearings 13a and 13b, and the first pulley 15a is placed between these two bearings. Along the first axis, on the other side of the second section, there is a cylindrical second axis 11b with the possibility of rotation, which is also placed between two bearings 13g and 13d, and a second pulley 15b is placed between the same bearings. The first and second glass washing mechanisms 8a and 8b, and the up-down movement switch, are located in the same section. The right and left sides of the frame are configured such that the cylindrical third axle 11g is rotatably inserted into the bearings 13e and 13v. The third and fourth pulleys 15g and 15d are placed at both ends of the specified axis, while the first pulley 15a of the first axis and the third pulley 15g of the third axis, as well as the second pulley 15b of the second axis and the fourth pulley 15d of the third axis are located along each other. The connecting elements 17a and 17b are attached to the toothed belts 16a and 16b. And on its surface facing the window, rubber is attached along the entire length of the element for cleaning windows, providing adhesion to the surface of the window.

Each switching mechanism 8a and 8b is a relay, the second 8b which when in contact with the corresponding element, ensures turning off and reversing the engine, and the first 8a turns off the engine.

In the first and second sections, the elements of the ventilation system are located. However, in the first section there is a ventilation engine 20. The air intake element is located in the second section, and in the first section the air passage element is formed in the form of holes in the partition between these sections. The ventilation motor 20 is connected to a ventilation slot 22 provided with a cover 21 provided on the outer plane of the first section.

The tank for the washing solution 1, the pump 2, the ventilation motor 20 and the reverse electric motor 9 are electrically connected to the software power unit.

Connecting elements 17a and 17b are made of plastic.

Window cleaning element 18 is made of aluminium.

The second section is performed with the possibility of placing a cleaning element in it.

The prototype allows automatic cleaning of windows and is also equipped with the ability to manually ventilate the interior space as a result of operator intervention.

The prototype is not equipped with the ability to ventilate the interior space automatically. On the other hand, the problem of automatic indoor ventilation is very relevant for such systems, especially for tall buildings, as the opening of the window is against the requirements of safety equipment and it is desirable that these windows do not open and thus ventilate the indoor spaces.

The prototype is not equipped with the ability to ventilate the interior space automatically. On the other hand, the problem of automatic indoor ventilation is very relevant for such systems, especially for tall buildings, as the opening of the window is against the requirements of safety equipment and it is desirable that these windows do not open and thus ventilate the indoor spaces.

A device for automatic window cleaning and ventilation, comprising a window cleaning element (5), a window cleaning element slider (3a) made in the form of toothed belts, a body made of a frame, mounted on a window frame (30) and a frame constructed as such: The section consists of two sections divided horizontally by a partition above the window surface (33 and 32), where the first section (32) is directed to the opposite side of the facade, while the second (33) is to the side of the façade attached to the bracket (10a). In addition, the engine shaft is connected to the pulley (2a) along the engine. On the other side of the second section, the first axis of rotational cylindrical shape (11a) is placed in two bearings (7th and 7d). The switch for moving the window cleaning element first and second mechanisms (8a and 8b) is located in the same section. The right and left sides of the frame are constructed in such a way that grooves are formed on their inner ridges, and the lower side of the frame is constructed in such a way that the bearings (7a, 7b, and 7c) are inserted in the bearings (7a, 7b, and 7c). The third (2c) and fourth axles (2d), the first axle of the engine shaft (2a) and the third axle (2g) of the second axle, as well as the second axle (22b) of the first axle and the fourth axle (2d) of the second axle, respectively, are placed next to each other. Fasteners (6a) are attached to the toothed belts (3a and 3b) where the connecting elements are mounted on brackets (6b) in which the ends of the window cleaning element (5) made in the form of a metal stem are attached so that the cleaning element is in a horizontal position with the window surface and the entire length of the window cleaning element (5). The rubber is attached to the surface of the window. However, the toothed belt (3b) is fastened by a plastic plate element (9) on the first axle (11a) and second axle (11b) pulley wheels (2b and 2d). The window cleaning element moves up and down (8b) to bring the second mechanism into action, and the first mechanism for moving up and down the window cleaning element (8a) is made directly by the action of the cleaning element (5). Each switching mechanism being a relay, the second (8b) of which provides engine (1) shutdown and reversing when in contact with the corresponding element. It also contains an additional washing solution valve (13) equipped with pipes (14a and 14b), a ventilation box (12), an ozonator (18), filters (20 and 29) speakers (25) and a control board (26). The Hose connecting the washing solution valve to the pump (13), the connecting pipe to the water valve pump (14b) and the ventilation box (12) are placed in the first section of the housing (32). The wash solution valve is also connected (separately from the washing solution tank pump) to the outlet hose (14a).

In addition, the system elements are located in the first (32) and second sections (33) of the device frame. The ventilation box (12), located in the first section, also acts as a partition (34) between the first and second sections. It is divided into four sections. On the front and back of the box there are ventilation holes. Ventilation holes are equipped with lids (21a and 21b), which can move through the belt (22a), and thus are equipped with the ability to close and open the air flow from the movement holes. As a result of opening and closing the ventilation openings, the inflow of air flow into the ventilation box is stopped. The belt (22a) is connected to the electric motor by four pulleys (23e, 23v, 23g and 23h). In the first section of the ventilation box (12) there are also 1 to 3 fans (15a) for air flow, and in front of the 1 to 3 fans there is a filter (29), which is wound on one wheel (16), The winding filter is turned on the second wheel where each wheel is equipped with an engine (17). In the same section there is an ozonator (18) and in front of it there is a moving charcoal filter (20). The carbon filter (20) is attached to the toothed belt (22b). The belt is attached to the pulleys (23a, 23b, 23g and 23d). The pulley (23g) is attached to the motor (24a), which allows the carbon filter (20) to move. The carbon filter moves or is taken when the ozonator is switched on with the appropriate software command and the interior of the building is ° zonated. When the ozonator is switched off, the coal filter returns to its original state or closes. When the coal filter is closed, the ozonator is switched on with the appropriate software command. The air is ° zonated, after which it passes through a closed charcoal filter, which removes 03. As a result, we receive oxygen-enriched air inside the building. Also placed in the second section are the control unit (26), the C02 sensor (27), the temperature and humidity sensors (28). The third section houses the “speaker” (25). In the fourth section there are 1 to 3 fans (15), which allows the interior of the building access to the air outlet from the space. The ventilation box in turn is connected to the top of the frame (31) and equipped with ventilation openings.

Additionally, the device contains four pulleys (2 e, 2 v, 2 z and 2 h) at the top of the frame, connected to the electric motor (1) for additional tension of the belt (3a and 3b).

Thus, the technical result of the proposed invention is to simplify the construction of the device, making it possible to clean the glass surface without human resources, which is also financially profitable. In this case, the glass cleaning, which is carried out by a climber and costs from 4 to 18 dollars per square meter depending on the complexity of the window, is reduced to 1 dollar per square meter through the proposed invention.

The invention is explained by five figures:

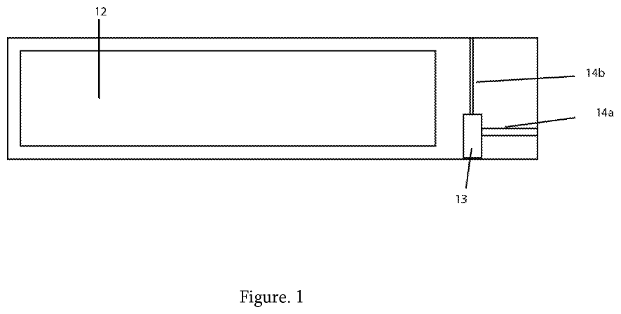

FIG. 1-Schematic representation of the first section is shown.

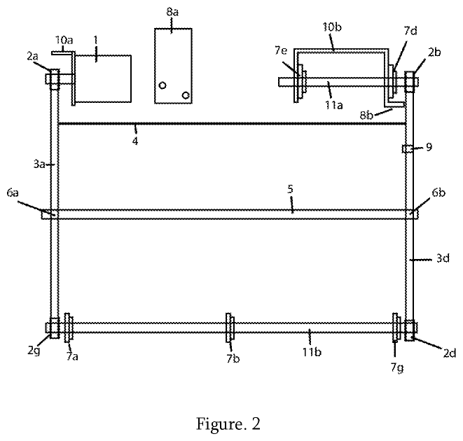

FIG. 2-A schematic representation of the second section and frame is shown.

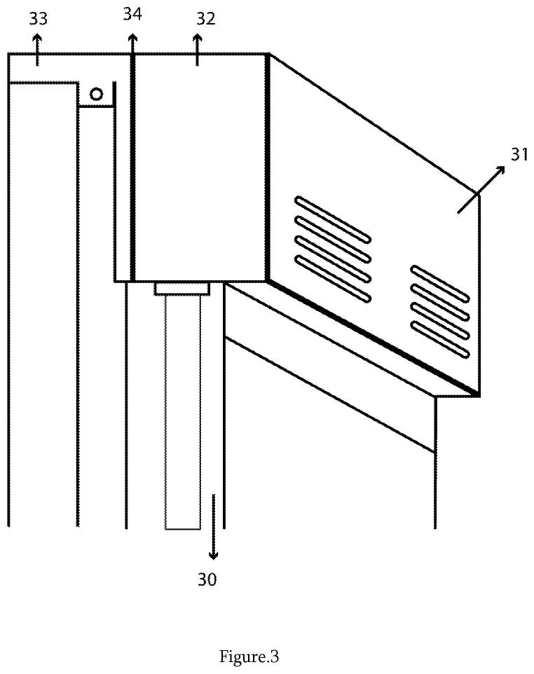

FIG. 3-The layout diagram of the device window frame is shown.

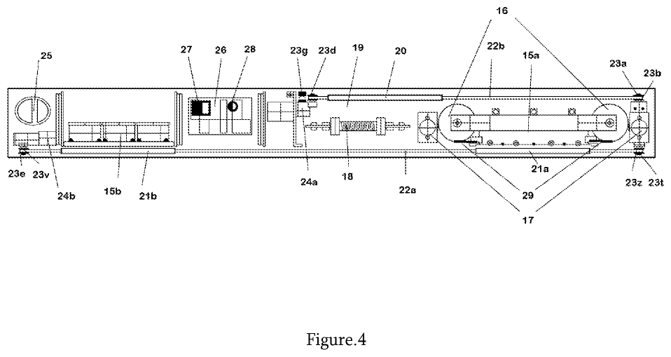

FIG. 4-A schematic drawing of 4 sections placed in the ventilation box is shown.

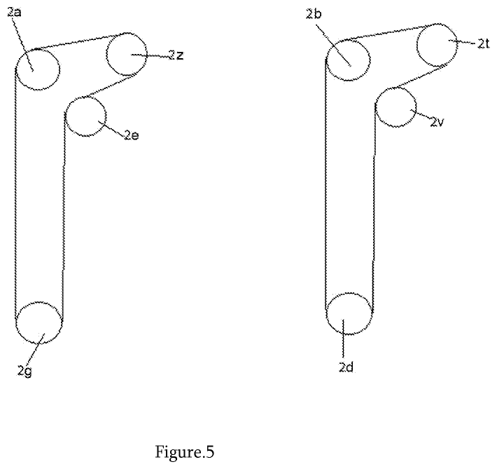

FIG. 5-The schematic image page of the second section and frame is shown.

After giving the appropriate order through the application, the software power unit block (26) is switched on. From the pump located in a separate tank, the washing solution is supplied to the aluminium perforated pipe (4) through the washing solution valve (13) through which said solution is supplied to the surface.

At the same time the electric motor (1) is switched on, the first pulley (2a) attached to it starts moving. This causes the first toothed belt to move in 3a. The movement is transmitted to the second axle (11a) and, accordingly, the second toothed belt (6b) moves the window cleaning element (5) from a top to bottom direction. At this point, the element (9) attached to the second toothed belt (6b) moves upwards and when it touches the second gear (8b) of the window cleaning element (5) located on the first axle, the window cleaning element (5) stops.

The time is calculated in such a way that at this point the cleaning element (5) is present on the lower side of the cleaning surface. At the same time, the cleaning element (5) starts moving from the bottom to the top through the reversing electric motor (1). When it reaches the top of the cleaning surface, it touches the first mechanism for moving the window cleaning element up and down (8a), causing the device to work. The second button of the application turns on 1 to 3 fans of the ventilation (15a and 15b) connected to the ventilation slot (31), and the building is ventilated.

The ventilation box works as follows: After giving the appropriate order through the application, the ventilation lids (21a and 21b) located in the first and third sections of the ventilation box (12) are activated, which move through the electric motor (24a), pulleys (23e, 23v, 23g, 23h) and belt (22a).

1 to 3 fans (15a and 15b) located in the first and third sections are switched on in parallel, with 1 to 3 fans introducing air from the first section (15a). From the first section enters the air through the HEPA filter (29). The ozonated air enters the indoor space through the coal filter (20) and we receive oxygen-enriched air (ionization). At the same time, in the third section 1 to 3 air vents (15b) are involved. After giving the appropriate order through the application, the ventilation lids located in the first and third sections of the ventilation box (12) are turned on (21a and 21b), which are driven by an electric motor (24a), pulleys (23e, 23v, 23z, 23h) and a belt (22a). 1 to 3 fans (15a and 15b) located in the third section are turned on in parallel. 1 to 3 fans introduce air from the first section (15a and 15b). The turbine introducing air from the first section (15a) introduces air through the HEPA filter (29) into the deaerator space (19). The carbon filter (20) located in front of the deaerator space moves to the left of the first section through the engine (24a), belt (22b), and pulleys (23a, 23b, 23c, 23d)., and ozonated air enters the interior of the building. At the same time, 1 to 3 fans (15b) of the third section air outlet are switched on as well as 1 to 3 fans (15a) located in the first section. The turbine (15a) located in the first section is constructed in such a way that the construction is marked on the sides with sockets suitable for toothed wheels. The wheels are attached to said socket (16) then rewind, which increases the filter length by 7-8 times, at the expense of the length of the HEPA filter (29) attached to the wheels.

A HEPA filter (self-priming filter) is compactly designed to extend the life of the air filter. The next button on the application turns on the speaker (25) in the fourth section and emits the sound from any device connected to it. In addition, all the functions of this window are managed through the control block (26) located in the second section. In addition, C02 (27), temperature and humidity sensors (28) are connected to the control unit (26) located in the second section. Consequently, all the information from the control block is transmitted to the server, and this window is managed automatically through the application. Clicking the next button in the application activates the fully automated window with the same functions as mentioned above.

1. A device for automatic window cleaning and ventilation, containing a window cleaning element, a window cleaning element moving in the form of toothed belts, a body, made in the form of a frame, attached to a window frame and designed so that the upper part of the window consists of the two sections placed horizontally above, where the first section is directed to the opposite side of the facade and the second to the side of the facade,
in addition, in the second section there is an aluminium perforated tube along its entire length and on one side of the second section there is a reversible electric motor, fastened to the bracket,
in addition, the engine shaft is connected to the pulley,
on the other side of the second section along the engine, the first axle of rotational cylindrical shape is placed, which is placed in two bearings,
in the same section the first and second mechanisms for moving the window cleaning element up and down are located,
the right and left sides of the frame are constructed in such a way that grooves are formed on their inner ridges,
the lower side of the frame is constructed in such a way that the second axis of the cylinder is inserted into the bearings placed in it with the possibility of rotation, the third and fourth pulleys are located at both ends of said axis,
the first pulley of the engine shaft and the third pulley of the second axle as well as the second pulley of the first axle and the fourth pulley of the second axle are placed parallel to each other,
fasteners are attached to the toothed belts, where mounts are attached to the connecting elements, in which the ends of the window cleaning element made in the form of a metal stem are fastened so that the cleaning element is in a horizontal position with respect to the window surface,
on the surface facing its window, along the entire length of the window cleaning element, rubber is attached to provide a surface mount,
an element made in the form of a plastic plate is attached to the toothed belt on the first axle and the second axle pulleys,
an up and down switch of the window cleaning element is activated by the second mechanism, and the first mechanism of the up and down movement of the window cleaning element is designed to be acted directly upon by the cleaning element,
each switch mechanism being a relay, the second of which, when in contact with the relevant element, provides engine shutdown and reversal, while the first engine shutdown differs in that it contains an additional washing solution valve equipped with hoses, ventilation box, ozonator, water filters, control board, and valves,
in addition, the water valve for the washing solution, the pipe connecting the water valve to the pump and the ventilation box are placed in the first section of the housing-frame, and
the water valve is also connected to the outlet pipe.

2. The device according to claim 1, in which the elements of the system is divided into four section, wherein in the first and second sections of the frame,
the ventilation box is located which also functions as a partition between the first and second sections:
ventilation cuts are marked on the front and back of the ventilation box,
ventilation openings are equipped with lids that can move through the belt, thus being able to close and open the air vents,
the belt is connected to the electric motor by two pulleys,
in the first section of the ventilation box, a turbine for air intake is also placed,
in front of the turbine there is a HEPA filter, which is wound on one wheel, the winding filter is turned on the other wheel, where each wheel is equipped with an engine,
in the same section an ozonator is placed and in front of it a moving charcoal filter is placed,
the charcoal filter is attached to the toothed belt, the belt is attached to the pulley, the pulley is attached to the engine, which allows the carbon filter to move,
the second section also includes a control board, C02 sensor, temperature and humidity sensors,
in the third section there is a turbine, through which air flows from the interior of the building,
in the fourth section there is a “speaker”, and
the ventilation box is connected to the upper part of the frame which is equipped with ventilation openings.

3. The Device according to claims 1-2, wherein said device additionally contains four pulleys at the top of the frame, connected to the electric motor for additional tension of the belt.
